(19) United States
(12) Patent Application Publication
(10) Pub. No.: US 2010/0314592 A1
(43) Pub. Date: Dec. 16, 2010

(54) METHOD FOR PROCESSING NUCLEAR FUELS CONTAINING SILICON CARBIDE AND FOR DECLADDING NUCLEAR FUEL PARTICLES

(75) Inventors: Stephane Bourg, Saint Thome (FR); Frederic Peron, Avignon (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: COMMISSARIAT A L'ENERGIE ATOMIQUE, Paris (FR)

(21) Appl. No.: 12/446,516

(22) PCT Filed: Oct. 23, 2007
(86) PCT No.: PCT/EP07/61369

§ 371 Date: Apr. 21, 2009

Related U.S. Application Data
(60) Provisional application No. 60/887,700, filed on Feb. 1, 2007.

(30) Foreign Application Priority Data
Oct. 24, 2006 (FR) 06 54464

(51) Int. Cl. G21G 4/00

(52) U.S. Cl. 252/636

(57) ABSTRACT

The present invention relates to a method for processing a nuclear fuel comprising a fissile material, SiC and possibly carbon, said method comprising the contacting of said fuel with a chlorine/oxygen mixture at a temperature below 950° C., and more particularly at a temperature between 400 and 900° C., so as to remove the SiC, and the carbon if this is present, from said fuel. The method of the invention makes it possible for example to declad TRISO or BISO nuclear fuel particles, i.e. particles enabling the nuclear fuel to be confined in a sheath or cladding, or to remove an SiC matrix from a fuel having a heterogeneous SiC matrix. The present invention therefore has many applications, especially in the reprocessing of irradiated nuclear fuels.

### TECHNICAL FIELD

The present invention relates to a method for processing nuclear fuels containing silicon carbide (SiC) and possibly carbon, as heterogeneous matrix.

The present invention relates in particular to a method for decladding (decanning) TRISO or BISO nuclear fuel particles.

TRISO particles are most commonly in the form of beads, generally of millimeter size, consisting of a kernel of fissile material and an external cladding or sheath enabling the fissile material to be confined. The fissile material of the kernel generally consists of oxides of actinides or more rarely carbides or oxycarbides of actinides. The cladding may be a monolayer or multilayer. In the most widely used TRISO nuclear fuels, the cladding comprises, from the kernel outwards: a porous carbon layer allowing fission gas expansion; a dense pyrolytic carbon layer; a silicon carbide layer; and again a pyrolytic carbon layer. BISO particles are TRISO particles without the external pyrolytic carbon layer.

### PRIOR ART

TRISO fuels were designed in the 1960s. The processing of this type of fuel by conventional techniques, for example by hydrometallurgy in a nitric acid medium in order to dissolve the fuel, is not practical from an industrial standpoint as it requires the particles to be ground up, resulting in the formation of nuclearly contaminated fines that are difficult to manage. In addition, studies carried out in the 1970s have shown that the degree of recovery is not quantitative.

Exclusively for analytical purposes, current techniques have proposed the use of gases for testing the integrity of TRISO-type particles before and/or after irradiation. According to these techniques, for example, for testing the integrity of an external carbon layer, the particles to be tested are subjected to chlorine at 1500° C. and the state of the SiC layer is then checked by radiography: destruction of the SiC layer indicates that the carbon layer is cracked. These techniques also make it possible to analyze the integrity of the internal carbon layers. This is because, in the case of a defect, volatile chlorinated uranium compounds form. To test the integrity of an SiC layer, the state of the internal carbon layers may be checked by mercury porosimetry after heating them to above 700° C. in oxygen. These analytical techniques are described for example in the following documents: Hewette et al., “Detection of defective SiC layers in coated nuclear fuel particles”, Nucl. Tech. Vol. 21, page 149, 1974; D. E. Lavalle et al., “The determination of defective particle fraction in high temperature gas-cooled reactor fuels”, Nucl. Tech. Vol. 33, page 290, 1976; D. A. Costanzo, “Energy programs: gas-cooled reactor programs”, ORNL-5100, pp. 33-41, 1976; and U.S. Pat. No. 4,227,081, (A. J. Caputo et al.) “Method of evaluating the integrity of the outer carbon layer of triso-coated reactor fuel particles”.

No processing method suitable for irradiated TRISO fuels enabling the aforementioned drawbacks to be solved has been developed hitherto, probably due to the fact that TRISO particles have not evoked much interest over the years 1975-2000.

However, at the present time, TRISO fuels are of renewed interest, especially for high-temperature nuclear reactor projects, and considerable research is being carried out throughout the world.

There is therefore a real need to develop methods enabling these current and future fuels to be reprocessed. These methods must be effective in respect of the degree of recovery and they must be clean, inexpensive, rapid and practical from the industrial standpoint.

### DESCRIPTION OF THE INVENTION

The inventors of the present invention have specifically provided such a method.

The method of the present invention is a method for processing a nuclear fuel comprising a fissile material contained in an SiC and possibly carbon cladding or coating, said method comprising the contacting of said fuel with a chlorine/oxygen mixture at a temperature below 950° C., in particular strictly below 950° C. and, more particularly, at a temperature between 400 and 900° C., so as to eliminate the SiC and the carbon, if this is present, from said fuel.

Thanks to the method of the invention, it is possible to volatilize the layers of SiC and of carbon, if present, of a nuclear fuel by chemical reaction with the chlorine/oxygen mixture.

The term “fissile material” is understood within the context of the present invention to mean any radioactive material that can be used to generate energy for the service of mankind.

The expression “nuclear fuel comprising a fissile material, SiC and possibly carbon” is understood within the context of the present invention to mean a nuclear fuel comprising a fissile material and SiC, or such a fuel that also includes carbon.

The term “heterogeneous matrix” is understood within the context of the present invention to mean that, in the nuclear fuel employed, the SiC and possibly the carbon are in the form of layers separate from the fissile material, such as a sheath, a cladding or a coating.

The method of the present invention is particularly suitable for the processing of nuclear fuels in the form of particles, more particularly in the form of particles comprising SiC and possibly carbon and, even more particularly, TRISO or BISO nuclear fuels. These may be particles comprising a kernel of fissile material and a (monolayer or multilayer) cladding comprising an alternation of carbon and SiC layers, for example as described above. The processing by the method of the invention is then in fact a treatment to declad said particles.

Within the context of the present invention, a fuel having a heterogeneous SiC matrix is a nuclear fuel in which the SiC and possibly the carbon are in the form of layers (the matrix) that are separate from the fissile material. When the nuclear fuel employed within the context of the present invention is such a fuel having a heterogeneous SiC matrix, the processing by the method of the invention is a treatment to remove said matrix, i.e. to eliminate said layers.

Currently, the kernel of TRISO or BISO fuels often consists of oxides of actinides and more rarely carbides or oxycarbides of actinides. The present invention applies not only to these fuels, but also to all fuels, irrespective of the nature of their kernel or of their cladding, whenever the latter comprises SiC and possibly carbon.

Furthermore, the method of the invention may be used not only in the aforementioned treatments, but also, for example, for extracting a fissile material by stripping the unwanted SiC and carbon therefrom.

The carbon is removed by combustion using oxygen. This chemical reaction takes place from 400° C. upwards, as shown by the thermogravimetric analyses carried out by the inventors of the present invention. Advantageously, pure oxygen is used for this removal.

The removal of SiC takes place in one step by a chemical reaction with the chlorine/oxygen mixture. Specifically, the inventors of the present invention have surprisingly noticed that at a temperature above 700° C., preferably above 800° C. and more preferably above 900° C., a chlorine/oxygen mixture attacks SiC and converts it entirely to SiCl₄ and COₓ, with neither solid carbon residues nor silica.

It is preferable to implement the method of the invention with a chlorine-rich (superstoichiometric) mixture so as to prevent the formation of silica. In this case, the mixture may for example be a mixture comprising 1 to 30%, advantageously 5 to 25%, particularly 10 to 25% and more particularly 15 to 20% by volume of oxygen and 70 to 99%, advantageously 75 to 95%, particularly 75 to 90% and more particularly 80 to 85% by volume of chlorine.

Preferably, the processing temperature must not exceed 1000° C., advantageously it should not exceed 950° C. and even more advantageously should be below, and in particular strictly below 950° C., so as to avoid any formation of volatile actinide chlorides.

It should be clear to a person skilled in the art that, within the particular temperature range provided, namely the range from 400° C. to 900° C., the limits of this range are inclusive within the present invention, just as are all the temperature values within this range. More particularly, the temperature of the method of the invention may be 400° C., 450° C., 500° C., 550° C., 600° C., 650° C., 700° C., 750° C., 800° C., 850° C. or 900° C.

Advantageously, according to the invention, the relative amount of chlorine and oxygen in the gas mixture may be modified according to the SiC and carbon content of the fuel to be processed. This enables the processing to be optimized and adapted to various types of fuel to be treated, during the processing itself.

For example, according to the invention, when the amount of SiC to be removed varies during the processing, the chlorine/oxygen mixture may be modified so as to follow this variation.

Thus, according to the invention, when the fuel comprises SiC and carbon, and when, at a moment M during the processing, one of the two following cases arises: (a) there is more SiC than carbon to be removed, or (b) there is more carbon than SiC to be removed, then, at said moment M, the chlorine/oxygen mixture may be modified so that there is more chlorine than oxygen in case (a) or more oxygen than chlorine in case (b), or even pure oxygen if only carbon remains to be removed.

Comparably, the processing carried out and, in particular, the amounts of oxygen and chlorine used and the temperature of the reaction will depend on the nature of the fuels to be processed and, more particularly, on the composition of the cladding (sheath or coating) of said fuels. To process a nuclear fuel whose cladding has external layers rich in carbon, the initial proportion of oxygen will lie within the high values of the ranges proposed above, or even at higher values, and the reaction temperature may be chosen within the low values of the ranges proposed above.

This is particularly advantageous for processing TRISO or BISO fuel particles comprising SiC and carbon layers. Thus, for the TRISO particles given by way of example above, it is possible to remove the external carbon layer by a prior treatment in pure oxygen at 400° C. before a chlorine/oxygen mixture rich in chlorine is used at higher temperatures, such as 700° C., 800° C. and preferably 900° C. At the end of the treatment, it is possible to increase the oxygen content.

As indicated above, the removal of SiC and of carbon, if this is present, generates gas emission. Advantageously, the chemical composition of said emission may be analyzed and the composition of the chlorine/oxygen mixture then modified according to this analysis. For example, this analysis may be carried out by quantitatively determining the contents of SiCl₄ and COₓ emitted during the processing. Such an analysis may be carried out for example by means of infrared spectrometry or mass spectrometry. The presence of SiCl₄ in the gases indicate the removal of SiC. This means keeping a relatively high chlorine content in the mixture. A COₓ content above the SiCl₄ (molar) content indicates an excess of carbon, which means advantageously increasing the relative amount of oxygen in the mixture.

The analysis and the modification of the mixture may be automated by means of mass flowmeters controlling the chlorine and oxygen streams, controlled by the SiCl₄ and COₓ contents in the combustion gases.

Of course, the contacting between the chlorine/oxygen mixture and the SiC, and possibly the carbon, is preferably carried out so as to promote the chemical reactions between this mixture and the SiC, and the carbon if it is present, of the fuel to be processed.

This contacting may be carried out, for example, in a reactor that includes means for heating and means for introducing the chlorine/oxygen mixture. Preferably, this reactor also includes means for stirring the fuel to be processed, so as to facilitate and optimize the contacting of said fuel with the chlorine/oxygen mixture and therefore the processing thereof. Preferably, this reactor also includes means for recovering, and optionally analyzing, the gases resulting from the removal of the SiC and carbon, if this is present. These analytical means and their functions will be explained below.

To summarize, the method of the invention serves in particular for the chemical decladding of nuclear fuel particles of the BISO or TRISO or SiC-matrix type. This involves chemical attack in the gas phase for volatilizing, for example between 400 and 900° C., the carbon (pyrolytic carbon and intermediate (“buffer”)), and SiC layers coating the kernel of fissile material.

The method of the present invention is clean, since only gaseous emanations without nuclearly contaminated fines are to be managed (“chemical decladding”).

The method of the present invention involves only simple chemical reactions and no radiation-sensitive reactants. The method may therefore apply to fuels having a short cooling time.

For all these reasons, and as the examples below show, the method of the present invention is rapid and practical from the industrial standpoint.

Other advantages may also be apparent to those skilled in the art on reading the examples below, which are illustrated by the appended figures, given by way of illustration.

### BRIEF DESCRIPTION OF THE DRAWINGS

FIG. 1 shows a three-dimensional graph produced using a thermodynamic approach of the action of a chlorine/oxygen mixture on SiC.

FIGS. 2a and 2b show two graphs indicating the effect of temperature (“T” expressed in ° C.) on the rate of volatilization of SiC, expressed as the weight loss (“Δw” expressed in % by weight), under the action of a chlorine/oxygen mixture.

FIG. 3 shows a graph comparing the effects of the chlorine and oxygen on SiC, expressed as the weight loss (“Δw” expressed in % by weight), as a function of the time (“t” in hours).

FIG. 4 shows a graph indicating the effect, as weight loss (“Δw” expressed in % by weight), as a function of the temperature (“T” expressed in ° C.), on the rate of volatilization of SiC under the action of a chlorine/oxygen mixture.

### EXAMPLES

### Example 1

### Thermodynamic Approach of the Action of Chlorine/Oxygen Mixtures on SiC

Thermodynamic calculations performed using the HSC (Outokumpu) software on the composition in equilibrium of a closed reactor system demonstrate that it is possible to volatilize the SiC in a single step using a chlorine/oxygen mixture rich in chlorine.

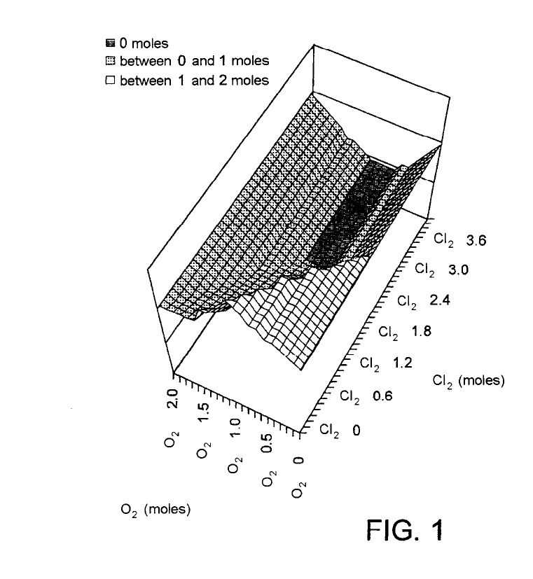

The appended FIG. 1 depicts the compositional region of the gas mixture for which theoretically there is no solid residue (the darkest region).

### Example 2

### Combustion of Carbon

Carbon combustion is effective from 400° C. upwards. This was confirmed experimentally by thermogravimetric analysis. In this experiment, pure oxygen was used.

SiC volatilization was confirmed on powder, on particles and on bulk specimens.

### Example 3

### Behavior of Powdered SiC in a Chlorine/Oxygen Mixture

A study for various temperatures shows that a temperature of 900° C. enabled SiC to be attacked quantitatively.

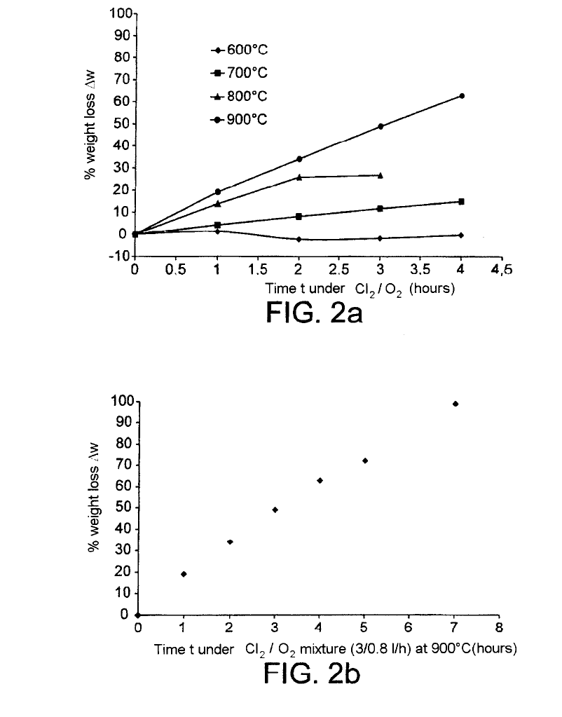

The results of this study are given in FIG. 2 below.

To obtain the results shown in FIG. 2a, a mixture consisting of 80% Cl₂ by volume and 20% oxygen by volume was used.

To obtain the results shown in FIG. 2b, a mixture consisting of 80% Cl₂ by volume and 20% oxygen by volume was used. The reaction was carried out at 900° C.

### Example 4

### Processing of BISO Particles According to the Invention

The BISO particles processed in this example were TRISO particles without the external carbon layer. The material of the core consisted of ZrO₂ simulating UO₂. The cladding comprised, from the kernel to the outside: a porous carbon layer, a dense pyrolytic carbon layer and an SiC layer.

The effects of chlorine alone, of chlorine alternating with oxygen, and of the chlorine/oxygen mixture on particles were compared.

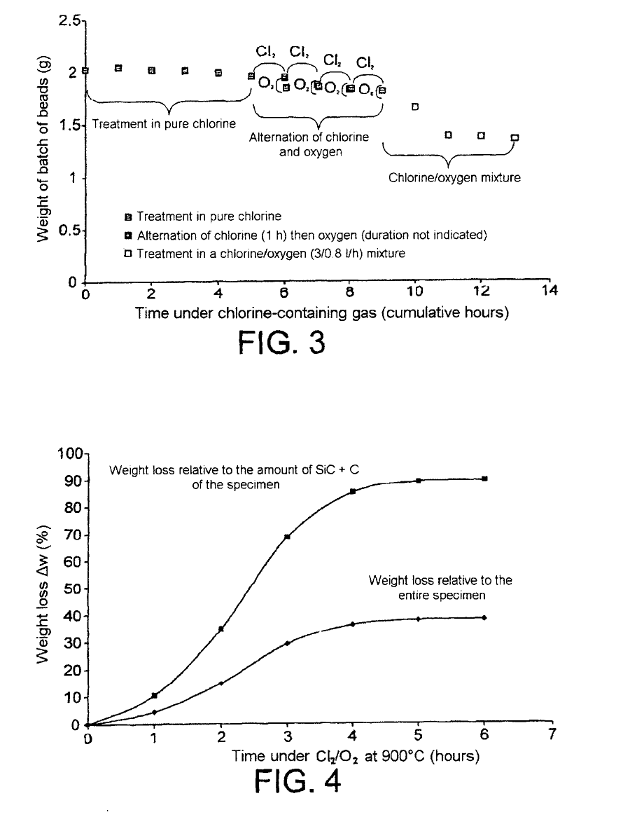

The results shown in the graph of FIG. 3 below indicate that only the chlorine/oxygen mixture is effective at 900° C. for volatilizing SiC.

FIG. 4 shows the weight loss measurements (in % by weight) relative to the amount of Si+C of the processed BISO fuel specimen (continuous solid curve) and the weight loss measurements (in % by weight) relative to the entire processed BISO fuel specimen (broken line curve). These measurements were carried out at a temperature of 900° C. with a mixture consisting of 80% Cl₂ by volume and 20% oxygen by volume.

1. A method for processing a nuclear fuel comprising a fissile material, SiC and optionally carbon, said method comprising contacting said fuel with a chlorine/oxygen mixture at a temperature below 950° C. so as to eliminate the SiC and any carbon present from said fuel.

2. The method according to claim 1, in which the chlorine/oxygen mixture is a mixture comprising 1 to 30% oxygen by volume and 70 to 99% chlorine by volume.

3. The method according to claim 1, in which, when the amount of SiC to be removed varies during the processing, the chlorine/oxygen mixture is modified so as to follow this variation.

4. The method according to claim 1, in which the fuel comprises SiC and carbon, in which, at a moment M during the processing, one of the following two cases arises: (a) there is more SiC than carbon to be removed, or (b) there is more carbon than SiC to be removed; and in which, at said moment M, the chlorine/oxygen mixture is specifically modified so that there is more chlorine than oxygen in case (a) or more oxygen than chlorine in case (b).

5. The method according to claim 1, in which the removal of the SiC and any carbon present generates gas emission, the chemical composition of said emission is determined and then the composition of the chlorine/oxygen mixture is modified according to this determination.

6. The processing method according to claim 1, in which the nuclear fuel is a TRISO or BISO fuel.

7. The processing method according to claim 6, in which the nuclear fuel consists of TRISO or BISO particles comprising SiC and carbon.

8. The processing according to claim 7, in which the particles comprise a kernel of fissile material and a cladding comprising an alternation of carbon and SiC layers, the processing being a treatment to declad the particles.

9. The method according to claim 1, in which the fissile material is chosen from the group consisting of oxides of actinides, carbides of actinides and oxycarbides of actinides.

10. The processing method according to claim 1, in which the nuclear fuel is a fuel having a heterogeneous SiC matrix, the processing being a treatment to remove said matrix.
